(19) United States
(12) Patent Application Publication
(10) Pub. No.: US 2021/0121865 A1
(43) Pub. Date: Apr. 29, 2021

(54) POROUS CATALYST CARRIER PARTICLES AND METHODS OF FORMING THEREOF

(71) Applicant: Saint-Gobain Ceramics & Plastics, Inc., Worcester, MA (US)

(72) Inventors: Stephen L. Dahar, Solon, OH (US); James A. McCarthy, Stow, OH (US); Jingyu Shi, Hudson, OH (US)

(73) Assignee: Saint-Gobain Ceramics & Plastics, Inc., Worcester, MA (US)

(21) Appl. No.: 16/948,695

(22) Filed: Sep. 29, 2020

Related U.S. Application Data
(60) Provisional application No. 62/910,674, filed on Oct. 4, 2019.

(51) Int. Cl. B01J 37/00; B01J 37/08; B01J 6/00; B01J 21/04; B01J 21/08; B01J 35/10; B01J 35/00; B01J 35/02; B01J 37/04

(52) U.S. Cl. CPC B01J 37/0072; B01J 37/08; B01J 6/001; B01J 21/04; B01J 37/04; B01J 35/1009; B01J 35/0026; B01J 35/023; B01J 35/1038; B01J 21/08

(57) ABSTRACT

A method of forming a batch of porous catalytic carrier particles may include applying a precursor mixture into a shaping assembly within an application zone to form a batch of precursor porous catalytic carrier particles, drying the batch of precursor porous catalytic carrier particles within the shaping assembly to form the batch of porous catalytic carrier particles, and directing an ejection material at the shaping assembly under a predetermined force to remove the batch of porous catalytic carrier particles from the shaping assembly. The batch of porous catalytic carrier particles may have an average pore volume of at least about 0.1 cm³/g.

### CROSS-REFERENCE TO RELATED APPLICATION

This application claims the benefit of U.S. Provisional Application No. 62/910,674 filed Oct. 4, 2019.

### FIELD OF THE INVENTION

The following is directed generally to porous catalyst carrier particles, and methods of making the same.

### BACKGROUND

Catalyst carriers may be used in a wide variety of applications and, in particular, the structural design of catalyst carriers is directly connected to their performance during a catalytic process. Generally, a catalyst carrier needs to possess, in combination, at least a minimum surface area on which a catalytic component may be deposited, known as a geometric surface area (GSA), high water absorption and crush strength. In addition, catalytic processes may include packing multiple catalyst carriers in a reactor tube where the general structure of the carriers affects the packing ability of the particles and thus the flow of fluid through the reactor tube. In such reactor tubes, geometric size and shape of the carrier, including GSA, must be balanced with the resistance to fluid flow caused by the packing of the catalytic particles, a performance parameter known as pressure drop and other parameters, such as, piece count. In addition, continuity in the shape of catalytic carrier particles can improve their overall performance. Maintaining the necessary balance between GSA and desired performance parameters of a catalyst carrier is achieved by extensive experimentation making the catalyst carrier art even more unpredictable than other chemical process art. Accordingly, the industry continues to demand improved catalyst carrier designs, and the ability to produce such particles in mass with consistent shape and size, in order to maximize desired carrier performance.

### SUMMARY

According to a first aspect, a method of forming a batch of porous catalytic carrier particles may include applying a precursor mixture into a shaping assembly within an application zone to form a batch of precursor porous catalytic carrier particles, drying the batch of precursor porous catalytic carrier particles within the shaping assembly to form the batch of greenware porous catalytic carrier particles, directing an ejection material at the shaping assembly under a predetermined force to remove the batch of greenware porous catalytic carrier particles from the shaping assembly, and firing (i.e. calcining) the batch of greenware porous catalytic carrier particles to form the batch of porous catalytic carrier particles. The batch of porous catalytic carrier particles may have an average pore volume of at least about 0.1 cm³/g.

According to still another aspect, a method of forming a batch of porous catalytic carrier particles may include applying a precursor mixture into a shaping assembly within an application zone to form a batch of precursor porous catalytic carrier particles, drying the batch of precursor porous catalytic carrier particles within the shaping assembly to form the batch of greenware porous catalytic carrier particles, directing an ejection material at the shaping assembly under a predetermined force to remove the batch of greenware porous catalytic carrier particles from the shaping assembly, and firing (i.e. calcining) the batch of greenware porous catalytic carrier particles to form the batch of porous catalytic carrier particles. The batch of porous catalytic carrier particles may have an average specific surface area of at least about 0.1 m²/g.

According to yet another aspect, a method of forming a batch of porous catalytic carrier particles may include applying a precursor mixture into a shaping assembly within an application zone to form a batch of precursor porous catalytic carrier particles, drying the batch of precursor porous catalytic carrier particles within the shaping assembly to form the batch of greenware porous catalytic carrier particles, directing an ejection material at the shaping assembly under a predetermined force to remove the batch of greenware porous catalytic carrier particles from the shaping assembly, and firing (i.e. calcining) the batch of greenware porous catalytic carrier particles to form the batch of porous catalytic carrier particles. The batch of porous catalytic carrier particles may have an average packing density of not greater than about 1.9 g/cm³.

According to still another aspect, a batch of porous catalytic carrier particles may have an average particle diameter of not greater than about 5.0 mm and a particle aspect ratio (AR) distribution span PARDS of not greater than about 50%, where PARDS is equal to (ARD₉₀−ARD₁₀)/ARD₅₀, where ARD₉₀ is equal to a ARD₉₀ particle aspect ratio (AR) distribution measurement of the batch of porous catalytic carrier particles, ARD₁₀ is equal to a ARD₁₀ particle aspect ratio (AR) distribution measurement of the batch of porous catalytic carrier particles and ARD₅₀ is equal to a ARD₅₀ particle aspect ratio (AR) distribution measurement of the batch of porous catalytic carrier particles.

According to still another aspect, a system for forming a batch of porous catalytic carrier particles may include an application zone comprising a shaping assembly, a drying zone, an ejection zone, and a firing zone. The application zone may include a first portion having an opening and may be configured to be filled with a precursor mixture to form a batch of precursor porous catalytic carrier particles, and a second portion abutting the first portion. The drying zone may include a first heat source and may be configured to dry the batch of precursor porous catalytic carrier particles to form the batch of greenware porous catalytic carrier particles. The ejection zone may include an ejection assembly configured to direct an ejection material toward the opening in the first portion of the shaping assembly to remove the batch of greenware porous catalytic carrier particles from the shaping assembly. The firing (i.e. calcining) zone may include a second heat source and may be configured to form the batch greenware porous catalytic carrier particles into the batch of porous catalytic carrier particles.

### BRIEF DESCRIPTION OF THE DRAWINGS

The present disclosure can be better understood, and its numerous features and advantages made apparent to those skilled in the art by referencing the accompanying drawings.

FIG. 1 is an illustration of a flowchart of a method of making a batch of porous catalytic carrier particles in accordance with an embodiment;

FIG. 2a includes a schematic of a system for forming a batch of porous catalytic carrier particles in accordance with an embodiment;

FIG. 2b includes an illustration of a portion of the system of FIG. 2a in accordance with an embodiment; and

FIG. 3 includes an illustration of a porous catalytic carrier particle formed according to embodiments described herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

The use of the same reference symbols in different drawings indicates similar or identical items.

### DETAILED DESCRIPTION

The following description, in combination with the figures, is provided to assist in understanding the teachings disclosed herein. The following discussion will focus on specific implementations and embodiments of the teachings. This discussion is provided to assist in describing the teachings and should not be interpreted as a limitation on the scope or applicability of the teachings.

The term “averaged,” when referring to a value, is intended to mean an average, a geometric mean, or a median value. As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but can include other features not expressly listed or inherent to such process, method, article, or apparatus. As used herein, the phrase “consists essentially of” or “consisting essentially of” means that the subject that the phrase describes does not include any other components that substantially affect the property of the subject.

Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “a” is employed to describe elements and components described herein. This is done merely for convenience and to give a general sense of the scope of the invention. This description should be read to include one or at least one and the singular also includes the plural, or vice versa, unless it is clear that it is meant otherwise.

Further, references to values stated in ranges include each and every value within that range. When the terms “about” or “approximately” precede a numerical value, such as when describing a numerical range, it is intended that the exact numerical value is also included. For example, a numerical range beginning at “about 25” is intended to also include a range that begins at exactly 25. Moreover, it will be appreciated that references to values stated as “at least about,” “greater than,” “less than,” or “not greater than” can include a range of any minimum or maximum value noted therein.

Embodiments described herein are generally directed to the formation of a batch of porous catalytic carrier particles having generally uniform shape (i.e. aspect ratio) throughout the batch.

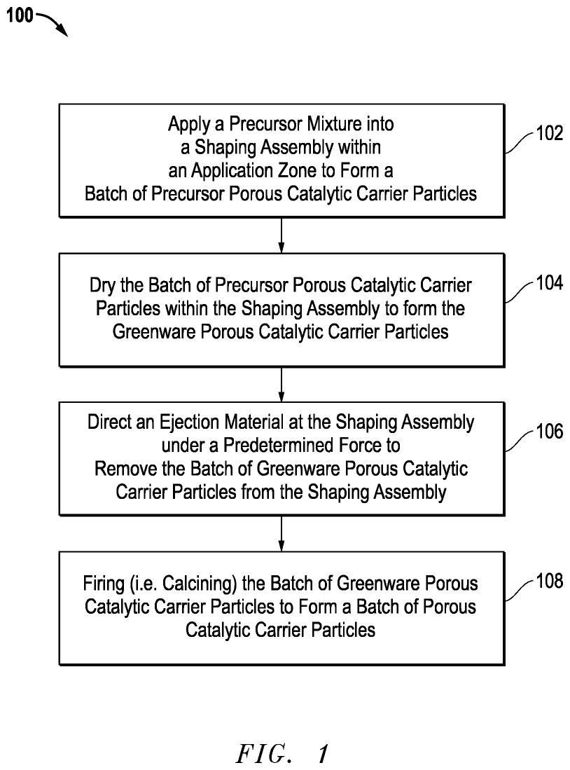

Referring initially to a method of forming a batch of porous catalytic carrier particles, FIG. 1 illustrates a porous catalytic carrier particles forming process generally designated 100. Porous catalytic carrier particles forming process 100 may include a first step 102 of applying a precursor mixture into a shaping assembly within an application zone to form a batch of precursor porous catalytic carrier particles, a second step 104 of drying the batch of precursor porous catalytic carrier particles within the shaping assembly to form a batch of greenware porous catalytic carrier particles, a third step 106 of directing an ejection material at the shaping assembly under a predetermined force to remove the batch of greenware porous catalytic carrier particles from the shaping assembly, and a fourth step 108 of firing (i.e. calcining) the batch or greenware porous catalytic carrier particles to form the batch of porous catalytic carrier particles.

According to still other embodiments, it will be appreciated that the porous catalytic carrier particles forming process 100 may include additional, optional, steps, such as, additional drying steps, which may occur at different times during the forming process 100. For example, the porous catalytic carrier particles forming process 100 may include an additional drying step between the third step 106 of directing an ejection material at the shaping assembly under a predetermined force to remove the batch of greenware porous catalytic carrier particles from the shaping assembly, and the fourth step 108 of firing (i.e. calcining) the batch or greenware porous catalytic carrier particles to form the batch of porous catalytic carrier particles.

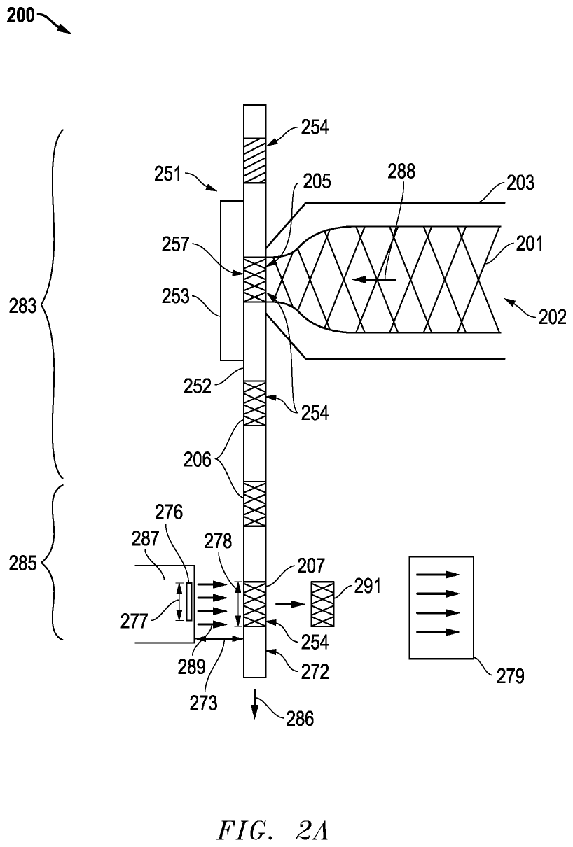

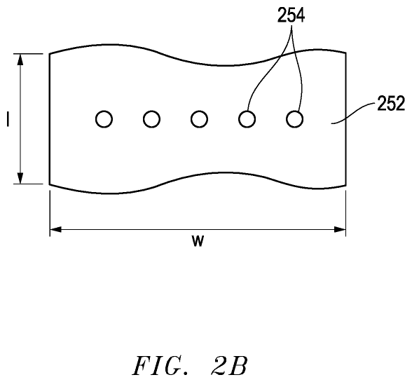

FIG. 2a includes an illustration of a system that may be used in forming a batch of porous catalytic carrier particles in accordance with embodiments described herein. As illustrated, a system 200 may include a die 203 configured to facilitate delivery of a precursor mixture 201 contained within a reservoir 202 of the die 203 to a shaping assembly 251. It will be appreciated, that forming process 100 as outlined in FIG. 1, may be carried out, for example, using system 200 as shown in FIG. 2a, but is not limited to being carried out using system 200.

Referring specifically to FIG. 2a, according to particular embodiments, the precursor mixture 201 can be provided within the interior of the die 203 and configured to be extruded through a die opening 205 positioned at one end of the die 203. As further illustrated, extruding can include applying a force (or a pressure) on the precursor mixture 201 to facilitate extruding the precursor mixture 201 through the die opening 205. In accordance with an embodiment, a particular pressure may be utilized during extrusion. For example, the pressure can be at least about 10 kPa, such as, at least about 500 kPa, at least about 1,000 kPa, at least about 2,000 kPa, or even at least about 3,000 kPa. According to still other embodiments, the pressure utilized during extrusion may be not greater than about 10,000 kPa, such as, not greater than about 8,000 kPa, or even not greater than about 6,000 kPa. It will be appreciated that the pressure utilized during extrusion may be any value between, and including, any of the minimum and maximum values noted above. It will be further appreciated that the pressure utilized during extrusion may be within a range between, and including, any of the minimum and maximum values noted above.

As further illustrated in FIG. 2a, the system 200 can include a shaping assembly 251. According to certain embodiments, the shaping assembly 251 may include a first portion 252 and a second portion 253. Notably, within the applications zone 283, the first portion 252 can be adjacent to the second portion 253. In more particular instances, within the application zone 283, the first portion 252 can be abutting a surface 257 of the second portion 253. According to yet other embodiments, the system 200 can be designed such that a portion of the shaping assembly 251, such as the first portion 252, may be translated between rollers. The first portion 252 may be operated in a loop such that the forming process can be conducted continuously.

As further illustrated in FIG. 2a, the system 200 can include an application zone 283, including the die opening 205 of the die 203. According to yet other embodiments, the process can further include applying the precursor mixture 201 into at least a portion of the shaping assembly 251. In particular embodiments, the process of applying the precursor mixture 201 can include depositing the precursor mixture 201 via a process, such as, extrusion, molding, casting, printing, spraying, and a combination thereof. In still other embodiments, such as that illustrated in FIG. 2a, the precursor mixture 201 may be extruded in a direction 288 through the die opening 205 and into at least a portion of the shaping assembly 251. Notably, a least a portion of the shaping assembly 251 can include at least one opening 254. In particular embodiments, such as that illustrated in FIG. 2a, the shaping assembly 251 can include a first portion 252 having an opening 254 configured to receive the precursor mixture 201 from the die 203.

In accordance with still other embodiments, the shaping assembly 251 can include at least one opening 254 that can be defined by a surface or multiple surfaces, including for example, at least three surfaces. In particular embodiments, the opening 254 can extend through an entire thickness of the first portion 252 of the shaping assembly 251. Alternatively, the opening 254 can extend through an entire thickness of the shaping assembly 251. Still, in other alternative embodiments, the opening 254 can extend through a portion of the entire thickness of the shaping assembly 251.

Referring briefly to FIG. 2b, a segment of a first portion 252 is illustrated. As shown, the first portion 252 can include an opening 254, and more particularly, a plurality of openings 254. The openings 254 can extend into the volume of the first portion 252, and more particularly, extend through the entire thickness of the first portion 252 as perforations. As further illustrated, the first portion 252 of the shaping assembly 251 can include a plurality of openings 254 displaced from each other along a length of the first portion 252. In particular embodiments, the first portion 252 may be translated in a direction 286 through the application zone 283 at a particular angle relative to the direction of extrusion 288. In accordance with an embodiment, the angle between the directions of translation 286 of the first portion 252 and the direction of extrusion 288 can be substantially orthogonal (i.e. substantially 90°). However, in other embodiments, the angle may be different, such as acute, or alternatively, obtuse.

In particular embodiments, the shaping assembly 251 can include a first portion 252 that may be in the form of a screen, which may be in the form of a perforated sheet. Notably, the screen configuration of the first portion 252 may be defined by a length of material having a plurality of openings 254 extending along its length and configured to accept the precursor mixture 201 as it is deposited from the die 203. The first portion can be in the form of a continuous belt that is moved over rollers for continuous processing. In certain embodiments, the belt can be formed to have a length suitable for continuous processing, including for example, at length of at least about 2 m, such as at least about 3 m.

In a particular embodiment, the openings 254 can have a two-dimensional shape as viewed in a plane defined by the length (l) and width (w) of the screen. While the openings 254 are illustrated as having a circular two-dimensional shape, other shapes are contemplated. For example, the openings 254 can have a two-dimensional shape such as polygons, ellipsoids, numerals, Greek alphabet letters, Latin alphabet letters, Russian alphabet characters, Arabic alphabet characters (or alphabet letters of any language), complex shapes including a combination of polygonal shapes, and a combination thereof. In particular instances, the openings 254 may have two-dimensional polygonal shapes such as, a triangle, a rectangle, a quadrilateral, a pentagon, a hexagon, a heptagon, an octagon, a nonagon, a decagon, and a combination thereof. Moreover, a first portion 252 can be formed to include a combination of openings 254 having a plurality of different two-dimensional shapes. It will be appreciated that the first portion 252 may be formed to have a plurality of openings 254 that may have different two-dimensional shapes as compared to each other.

In other embodiments, the shaping assembly 251 may be in the form of a mold. In particular, the shaping assembly 251 can be in the shape of a mold having openings 254 defining side surfaces and a bottom surface configured to accept the precursor mixture 201 from the die 203. Notably, a mold configuration may be distinct from a screen configuration such that the mold has openings that do not extend through the entire thickness of the shaping assembly 251.

In one design, the shaping assembly 251 can include a second portion 253 configured to be adjacent to the first portion 252 within the application zone 283. In particular instances, the precursor mixture 201 can be applied into the opening 254 of the first portion 252 and configured to abut a surface 257 of the second portion 253 within the application zone 283 to form a precursor porous catalytic carrier particle 206. For one particular design, the second portion 253 can be configured as a stop surface allowing the precursor mixture 201 to fill the opening 254 within the first portion 252 to form the precursor porous catalytic carrier particle 206.

According to one embodiment, the surface 254 of the second portion 253 can be configured to contact the precursor mixture 201 while it is contained within the opening 254 of the first portion 252. The surface 257 may have a particular coating to facilitate processing. For example, the surface 257 may include a coating including an inorganic material, an organic material, and a combination thereof. Some suitable inorganic materials can include a ceramic, a glass, a metal, a metal alloy, and a combination thereof. Certain suitable examples of an organic material can include a polymer, including for example, a fluoropolymer, such as polytetrafluoroethylene (PTFE).

Alternatively, the surface 257 may include features, including for example protrusions and grooves such that during processing the precursor porous catalytic carrier particle 206 contained within the opening 254 of the first portion 252 may replicate features contained on the surface 257 of the second portion 253.

As described herein, in particular embodiments, the first portion 252 may be translated in a direction 286. As such, within the application on 283, the precursor mixture 201 contained in the openings 254 of the first portion 252 may be translated over the surface 257 of the second portion 253. In accordance with an embodiment, the first portion 252 may be translated in a direction 286 at a particular rate to facilitate suitable processing. For example, the first portion 252 may be translated through the application zone 283 at a rate of at least about 0.5 mm/s. In other embodiments, the rate of translation of the first portion 252 may be greater, such as at least about 1 cm/s, at least about 3 cm/s, at least about 4 cm/s, at least about 6 cm/s, at least about 8 cm/s, or even at least about 10 cm/s. Still, in at least one non-limiting embodiment, the first portion 252 may be translated in a direction 286 at a rate of not greater than about 5 m/s, such as not greater than about 1 m/s, or even not greater than about 0.5 m/s. It will be appreciated that the first portion 252 may be translated at a rate within a range between any of the minimum and maximum values noted above.

After applying the precursor mixture 201 in the openings 254 of the first portion 252 of the shaping assembly 251 to form the precursor porous catalytic carrier particle 206, the first portion 252 may be translated to an ejection zone 285. Translation may be facilitated by a translator configured to translate at least a portion of the shaping assembly from the application zone 283 to the ejection zone 285. Some suitable examples of a translator may include a series of rollers, about which the first portion 252 may be looped and rotated around.

During translation to the ejection zone 245, the precursor porous catalytic carrier particle 206 may be dried to for a greenware catalytic carrier particle 207.

The ejection zone may include at least one ejection assembly 287 that can be configured to direct an ejection material 289 at the greenware porous catalytic carrier particle 207 contained within the openings 254 of the first portion 252. In a particular embodiment, during the translation of the first portion 252 from the application zone 283 to the ejection zone 285, only a portion of the shaping assembly 251 may be moved. For example, the first portion 252 of the shaping assembly 251 may be translated in a direction 286, while at least the second portion 253 of the shaping assembly 251 may be stationary relative to the first portion 252. That is, in particular instances the second portion 253 may be contained entirely within the application zone 283 and may be removed from contact with the first portion 252 within the ejection zone 285. In particular instances, the second portion 253, which in certain embodiments may be alternatively referred to as the backing plate, terminates prior to the ejection zone 285.

The first portion 252 can be translated from the application zone 283 into the ejection zone 285, where opposing major surfaces of the greenware porous catalytic carrier particle 207 contained within the openings 254 of the first portion 252 may be exposed. In certain instances, exposure of both major surfaces of the precursor mixture 201 in the openings 254 can facilitate further processing, including for example, ejection of the greenware porous catalytic carrier particle 207 from the openings 254.

As further illustrated in the assembly 200, in particular embodiments, the first portion 252 of the shaping assembly 251 can be in direct contact with the second portion 253 of the shaping assembly 251 within the application zone 283. Moreover, prior to translating the first portion 252 from the application zone 283 to the ejection zone 285, the first portion 252 can be separated from the second portion 253. As such, the greenware porous catalytic carrier particle 207 contained within the openings 254 can be removed from at least one surface of a portion of the shaping assembly 251, and more particularly, the surface 257 of the second portion 253 of the shaping assembly 251. Notably, the greenware porous catalytic carrier particle 207 contained within the opening 254 can be removed from the surface 257 of the second portion 253 prior to ejection of the greenware porous catalytic carrier particle 207 from the openings 254 in the ejection zone 285. The process of removing the greenware porous catalytic carrier particle 207 from the first portion 252 of the shaping assembly 251 can be conducted after removing the second portion 253 from contact with the first portion 252.

In one embodiment, the ejection material 289 can be directed at the first portion 252 of the shaping assembly 251 to facilitate contact with the greenware porous catalytic carrier particle 207 in the openings 254 of the first portion 252. In particular instances, the ejection material 289 can directly contact an exposed major surface of the greenware porous catalytic carrier particle 207 and an opening 254 of the first portion 252 of the shaping assembly 251. As will be appreciated, at least a portion of the ejection material 289 may also contact a major surface of the second portion 252 as it is translated by the ejection assembly 287.

In accordance with an embodiment, the ejection material 289 can be a fluidized material. Suitable examples of fluidized materials can include a liquid, a gas, and a combination thereof. In one embodiment, the fluidized material of the ejection material 289 can include an inert material. Alternatively, the fluidized material can be a reducing material. Still, in another particular embodiment, the fluidized material may be an oxidizing material. According to one particular embodiment, the fluidized material can include air.

In an alternative embodiment, the ejection material 289 may include an aerosol comprising a gas phase component, a liquid phase component, a solid phase component, and a combination thereof. In yet another embodiment, the ejection material 289 can include an additive. Some suitable examples of additives can include materials such as an organic material, an inorganic material, a gas phase component, a liquid phase component, a solid phase component, and a combination thereof. In one particular instance, the additive can be a dopant material configured to dope the material of the precursor mixture 201. In accordance with another embodiment, the dopant can be a liquid phase component, a gas phase component, a solid phase component, or a combination thereof that can be contained within the ejection material. Still, in one particular instance, the dopant can be present as a fine powder suspended in the ejection material.

Directing the ejection material at the greenware porous catalytic carrier particle 207 in the opening 254 of the first portion 252 of the shaping assembly 251 can be conducted at a predetermined force. The predetermined force may be suitable to eject the greenware porous catalytic carrier particle 207 from the opening 254, and may be a function of the rheological parameters of the precursor porous catalytic carrier particle 206, the geometry of the cavity, the materials of construction of shaping assembly, surface tension forces between the greenware porous catalytic carrier particle 207 and the materials of the shaping assembly 251, and a combination thereof. In one embodiment, the predetermined force can be at least about 0.1 N, such as at least about 1 N, at least about 10 N, at least about 12 N, at least about 14 N, at least about 16 N, at least about 50 N, or even at least about 80 N. Still, in one non-limiting embodiment, the predetermined force may be not greater than about 500 N, such as not greater than about 200 N, not greater than about 100 N, or even not greater than about 50 N. The predetermined force may be within a range between any of the minimum and maximum values noted above.

Notably, the use of the ejection material 289 may be essentially responsible for the removal of the greenware porous catalytic carrier particle 207 from the opening 254. More generally, the process of removing the greenware porous catalytic carrier particle 207 from an opening 254 can be conducted by applying an external force to the greenware porous catalytic carrier particle 207. Notably, the process of applying external force includes limited strain of the shaping assembly and an application of an outside force to eject the greenware porous catalytic carrier particle 207 from the opening 254. The process of ejection causes removal of the greenware porous catalytic carrier particle 207 from the opening 254 and may be conducted with relatively little or essentially no shearing of the first portion 252 relative to another component (e.g., the second portion 253). Moreover, ejection of the precursor mixture may be accomplished with essentially no drying of the greenware porous catalytic carrier particle 207 within the opening 254. As will be appreciated, the batch of porous catalytic carrier particles 291 may be ejected from the opening 254 and collected. Some suitable methods of collecting can include a bin underlying the first portion 252 of the shaping assembly 251. Alternatively, the greenware porous catalytic carrier particle 207 can be ejected from the opening 254 in such a manner that a batch of greenware porous catalytic carrier particles 291 falls back onto the first portion 252 after ejection.

The batch of greenware porous catalytic carrier particles 291 can be translated out of the ejection zone on the first portion 252 to other zones for further processing, such as, to a firing zone for firing (i.e. calcining) the batch of greenware porous catalytic carrier particles 291 to form the batch of porous catalytic carrier particles.

It will be appreciated that alternative embodiments may include production of the final batch of porous catalytic carrier particles from the greenware porous catalytic carrier particles without firing. Accordingly, for purpose of such embodiments, the batch of greenware porous catalytic carrier particles 291 may become the batch of porous catalytic carrier particles as soon as they are translated away from the ejection zone.

In accordance with an embodiment, the greenware porous catalytic carrier particle 207 can experience a change in weight of less than about 80% for the total weight of the greenware porous catalytic carrier particle 207 for the duration the greenware porous catalytic carrier particle 207 is in the opening of the first portion 252 of the shaping assembly 251. In other embodiments, the weight loss of the greenware porous catalytic carrier particle 207 while it is contained within the shaping assembly 251 can be less, such as less than about 75%, less than about 70%, less than about 65%, less than about 60%, or even less than about 55%. According to still other embodiments, the weight loss of the greenware porous catalytic carrier particle 207 while it is contained within the shaping assembly 251 can be at least about 20%, such as, at least about 25% or at least about 30% or even at least about 35%.

Furthermore, during processing, the greenware porous catalytic carrier particle 207 may experience a change in volume (e.g., shrinkage) for the duration the greenware porous catalytic carrier particle 207 is in an opening 254 of the shaping assembly 251. For example, the change of volume of the greenware porous catalytic carrier particle 207 can be at least about 1% for the total volume of the greenware porous catalytic carrier particle 207 for the duration between applying the greenware porous catalytic carrier particle 207 in the opening and ejection of the precursor mixture from the opening 254, such as, at least about 3% or at least about 5% or at least about 10% or at least about 15% or at least about 20% or at least about 25% or at least about 30% or at least about 35% or at least about 40% or even at least about 45%. According to still other embodiments, the change of volume of the greenware porous catalytic carrier particle 207 can be less than about 60% for the total volume of the precursor mixture 201 for the duration between applying the greenware porous catalytic carrier particle 207 in the opening and ejection of the precursor mixture from the opening 254. In other embodiments, the total change in volume may be less, such as less than about 58%, less than about 55%, or even less than about 53%.

In accordance with an embodiment, the greenware porous catalytic carrier particle 207 may undergo a controlled heating process, while the precursor mixture is contained within the shaping assembly 251. For example, the heating process may include heating the precursor mixture at a temperature greater than room temperature for a limited time. The temperature may be at least about 30° C., such as at least about 35° C., at least about 40° C., such as at least about 50° C., at least about 60° C., or even at least about 100° C. Still, the temperature may be not greater than about 30° C., such as not greater than about 200° C., or even not greater than about at least about 150° C., or even not greater than about 100° C. The duration of heating can be particularly short, such as, not greater than about 10 minutes, not greater than about 5 minutes, not greater than about 3 minutes, not greater than about 2 minutes, or even not greater than about 1 minute.

The heating process may utilize a radiant heat source, such as infrared lamps to facilitate controlled heating of the greenware porous catalytic carrier particle 207. Moreover, the heating process may be adapted to control the characteristics of the precursor mixture and facilitate particular aspects of the porous catalytic carrier particles according to embodiments herein.

In accordance with an embodiment, the process of ejecting the greenware porous catalytic carrier particle 207 from an opening 254 of the shaping assembly 251 can be conducted at a particular temperature. For example, the process of ejection can be conducted at a temperature of not greater than about 300° C. In other embodiments, the temperature during ejection can be not greater than about 250° C., not greater than about 200° C., not greater than about 180° C., not greater than about 160° C., not greater than about 140° C., not greater than about 120° C., not greater than about 100° C., not greater than about 90° C., not greater than about 60° C., or even not greater than about 30° C. Alternatively, in a non-limiting embodiment, the process of directing an ejection material at the precursor mixture and ejecting the greenware porous catalytic carrier particle 207 from an opening 251 may be conducted at certain temperatures, including those temperatures that may be above room temperature. Some suitable temperatures for conducting the ejection process can be at least about −80° C., such as at least about −50° C., at least about −25° C., at least about 0° C., at least about 5° C., at least about 10° C., or even at least about 15° C. It will be appreciated that in certain non-limiting embodiments, the process of ejecting the greenware porous catalytic carrier particle 207 from an opening 254 may be conducted at a temperature within a range between any of the temperatures noted above.

Furthermore, it will be appreciated that the ejection material 289 may be prepared and ejected from the ejection assembly 287 at a predetermined temperature. For example, the ejection material 289 may be at a temperature significantly less than the surrounding environment, such that upon contact with the greenware porous catalytic carrier particle 207 within the opening 254, the precursor mixture is configured to be reduced in temperature. During the ejection process, the greenware porous catalytic carrier particle 207 may be contacted by the ejection material 289 that can be cooler in temperature than the temperature of the greenware porous catalytic carrier particle 207 causing contraction of the material of the greenware porous catalytic carrier particle 207 and ejection from the opening 254.

In accordance with an embodiment, the ejection assembly 287 can have a particular relationship with respect to the openings 254 of the shaping assembly 251 to facilitate suitable formation of a batch of porous catalytic carrier particles according to an embodiment. For example, in certain instances, the ejection assembly 287 can have an ejection material opening 276 from which the ejection material 289 exits the ejection assembly 287. The ejection material opening 276 can define an ejection material opening width 277. Furthermore, the openings 254 of the first portion 252 can have a shaping assembly opening width 278 as illustrated in FIG. 2a, which may define a largest dimension of the opening in the same direction as the ejection material opening width 277. In particular instances, the ejection material opening width 277 can be substantially the same as the shaping assembly opening width 278.

Moreover, the gap distance 273 between the surface of the ejection assembly 287 and the first portion 252 of the shaping assembly can be controlled to facilitate formation of porous catalytic carrier particles according to an embodiment. The gap distance 273 may be modified to facilitate forming porous catalytic carrier particles with certain features or limiting the formation of certain features.

It will further be appreciated that a pressure differential may be created on opposite sides of the first portion 252 of the shaping assembly 251 within the ejection zone 285. In particular, in addition to use of the ejection assembly 287, the system 200 may utilize an optional system 279 (e.g., a reduced pressure system) configured to reduce the pressure on the opposite side of the first portion 252 from the ejection assembly 287 to facilitate pulling the batch of porous catalytic carrier particles 291 from the opening 254. The process may include providing a negative pressure difference on the side of the shaping assembly opposite the ejection assembly 287. It will be appreciated that balancing the predetermined force of the ejection material and the negative pressure applied to the back side 272 of the first portion 252 of the shaping assembly within the ejection zone 285 can facilitate formation of different shape features in the batch of porous catalytic carrier particles 291 and the final-formed porous catalytic carrier particles.

After ejecting the greenware porous catalytic carrier particle 207 from the opening 254 of the first portion 252, a batch of greenware porous catalytic carrier particles is formed, and then a batch of porous catalytic carrier particles is formed. According to a particular embodiment, the batch of greenware porous catalytic carrier particles, and/or the batch of porous catalytic carrier particles can have a shape substantially replicating the shape of the openings 254.

Referring now to the precursor mixture (i.e. the precursor mixture described in reference to forming process 100 and/or the precursor mixture 201 described in reference to system 200), according to certain embodiments, the precursor mixture may include any combination of materials necessary for forming a porous catalytic carrier particle. For example, the precursor mixture may include, as primary constituents, materials such as alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof. According to still other embodiments, additional components may include water, organic solvents, acids, bases, organic additives, and metal dopants.

Referring now to the batch of greenware porous catalytic carrier particles (i.e. the batch of greenware porous catalytic carrier particles described in reference to forming process 100 and/or the batch of greenware porous catalytic carrier particles described in reference to system 200), according to certain embodiments, the batch of greenware porous catalytic carrier particles may include as primary constituents, materials such as alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof. According to still other embodiments, additional components may include water, organic solvents, acids, bases, organic additives, and metal dopants.

Referring now to the batch of porous catalytic carrier particles (i.e. the batch of porous catalytic carrier particles described in reference to forming process 100 and/or the batch of porous catalytic carrier particles described in reference to system 200), according to certain embodiments, the batch of porous catalytic carrier particles may include the batch of porous catalytic carrier particles may include materials such as alumina, silica, titania, zirconia, magnesia, silicon carbide, carbon, zeolites, metal organic frameworks (MOFs), spinels, perovskites, and combinations thereof. According to still other embodiments, metal dopants may be present in concentration of less than 10 weight percent.

According to still other embodiments, the batch of porous catalytic carrier particles may have particular average pore volume. For purposes of embodiments described herein, the average pore volume of a sample of the batch or porous catalytic carrier particles is measured using a conventional mercury intrusion porosimetry device in which liquid mercury is forced into the pores of a carrier. Greater pressure is needed to force the mercury into the smaller pores and the measurement of pressure increments corresponds to volume increments in the pores penetrated and hence to the size of the pores in the incremental volume. As used herein, average pore volume is measured by mercury intrusion porosimetry (capable pressure range of 0.4-60,000 psi) using a Micromeritics AutoPore IV 9500 Series (130° contact angle, mercury with a surface tension of 0.480 N/m, and correction for mercury compression applied).

According to particular embodiments, the batch of porous catalytic carrier particles may have an average pore volume of at least about 0.1 cm³/g, such as, at least about 0.15 cm³/g or at least about 0.2 cm³/g or at least about 0.25 cm³/g or at least about 0.3 cm³/g at least about 0.35 cm³/g or at least about 0.4 cm³/g or at least about 0.45 cm³/g or at least about 0.5 cm³/g or at least about 0.55 cm³/g or at least about 0.6 cm/g or at least about 0.65 cm³/g or at least about 0.7 cm³/g or at least about 0.75 cm³/g or even at least about 0.8 cm³/g. According to still other embodiments, the batch of porous catalytic carrier particles may have an average pore volume of not greater than about 10 cm³/g, such as, not greater than about 9 cm³/g or not greater than about 8 cm³/g or not greater than about 7 cm³/g or not greater than about 6 cm³/g or even not greater than about 5 cm³/g. It will be appreciated that the average pore volume of the batch of porous catalytic carrier particles may be any value between, and including, any of the minimum and maximum values noted above. It will be further appreciated that the average pore volume of the batch of porous catalytic carrier particles may be within a range between, and including, any of the minimum and maximum values noted above.

According to still other embodiments, the batch of porous catalytic carrier particles may have particular average specific surface area. For purposes of embodiments described herein, the average specific surface area of a sample of the batch of porous catalytic carrier particles is determined by the BET method. A sample is first degassed at 250° C. for 2 hours prior to analysis. The Micromeritics ASAP 2420 is then used to determine the surface area of the sample using a 5-point BET analysis.

According to particular embodiments, the batch of porous catalytic carrier particles may have an average specific surface area of at least about 0.1 m/g, such as, at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or even at least about 200 m²/g. According to still other embodiments, the batch of porous catalytic carrier particles may have an average specific surface area of not greater than about 2000 m²/g, such as, not greater than about 1500 m²/g or not greater than about 1000 m²/g or not greater than about 500 m²/g or not greater than about 400 m²/g or even not greater than about 300 m²/g. It will be appreciated that the average specific surface area of the batch of porous catalytic carrier particles may be any value between, and including, any of the minimum and maximum values noted above. It will be further appreciated that the average specific surface area of the batch of porous catalytic carrier particles may be within a range between, and including, any of the minimum and maximum values noted above.

According to still other embodiments, the batch of porous catalytic carrier particles may have particular average packing density. For purposes of embodiments described herein, average packing density is measured using a 100 mL graduated cylinder, which is weighed and then filled to the 100 mL level with a sample of the batch of porous catalytic carrier particles. A AT-2 Autotap Tap Density Analyzer (manufactured by Quantachrome Instruments located in Boynton Beach, Fla., USA) is set to perform 1000 taps and tapping is initiated. After completion of 1000 taps, the volume of the sample is measured to the nearest 0.5 mL. The sample and graduated cylinder are then weighed and the mass of the empty graduated cylinder is subtracted to yield the mass of the sample, which is then divided by the volume of the sample to obtain the packing density.

According to particular embodiments, the batch of porous catalytic carrier particles may have an average packing density of not greater than about 1.9 g/cm³, such as, not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or even not greater than about 1.0 g/cm³. According to still other embodiments, the batch of porous catalytic carrier particles may have an average packing density of at least about 0.1 g/cm³. It will be appreciated that the average packing density of the batch of porous catalytic carrier particles may be any value between, and including, any of the minimum and maximum values noted above. It will be further appreciated that the average packing density of the batch of porous catalytic carrier particles may be within a range between, and including, any of the minimum and maximum values noted above.

According to yet other embodiments, the batch of porous catalytic carrier particles may have a particular Geopycnometer density. For purposes of embodiments described herein, Geopycnometer density is measured using a Micromeritics Geo-Pycnometer 1360 instrument. This instrument determines density by measuring the change in volume when a sample of known mass is introduced in to a chamber containing Micromeritics DryFlo™. DryFlo consists of small beads covered in graphite powder. A calibration is first performed with only DryFlo present in the cylindrical sample chamber. The contents of the chamber are pressed by a plunger to a maximum force of 90 N, and the distance that the plunger is pressed to achieve this force is recorded by the instrument. From this distance measurement, the volume of the DryFlo within the sample chamber is calculated by the instrument. This cycle is repeated five times for the calibration, and the average volume is obtained. The chamber and plunger are then removed and a sample of the batch of porous catalytic carrier particles of known mass (about 2.5 grams) is added to the DryFlo in the chamber. The measured mass is input into the instrument. The process of pressing the plunger to a maximum force of 90 N is then repeated for five cycles with the sample present in the chamber. The instrument calculates the average volume of the DryFlo-sample mixture from the distance that the plunger was pressed for each cycle. By subtracting the average volume for the DryFlo calibration from the average volume for the DryFlo-sample run, the volume of the sample is obtained. With the mass of the sample known, the instrument outputs the density of the sample by dividing mass by volume.

According to yet other embodiments, the batch of porous catalytic carrier particles may have a Geopycnometer density of at least about 0.1 g/cm³, such as, at least about 0.12 g/cm³ or at least about 0.14 g/cm³ or at least about 0.16 g/cm³ or at least about 0.18 g/cm³ or at least about 0.2 g/cm³ or even at least about 0.22 g/cm³. According to still other embodiments, the batch of porous catalytic carrier particles may have a Geopycnometer density of not greater than about 5.0 g/cm³, such as, not greater than about 4.75 g/cm³ or not greater than about 4.5 g/cm³ or not greater than about 4.25 g/cm³ or not greater than about 4.0 g/cm³ or not greater than about 3.75 g/cm³ or not greater than about 3.5 g/cm³ or not greater than about 3.25 g/cm³ or not greater than about 3.0 g/cm³ or not greater than about 2.75 g/cm³ or not greater than about 2.5 g/cm³ or not greater than about 2.4 g/cm³ or not greater than about 2.3 g/cm³ or not greater than about 2.28 g/cm³ or not greater than about 2.26 g/cm³ or not greater than about 2.24 g/cm³ or even not greater than about 2.22 g/cm³. It will be appreciated that the Geopycnometer density of the batch of porous catalytic carrier particles may be any value between, and including, any of the minimum and maximum values noted above. It will be further appreciated that the Geopycnometer density of the batch of porous catalytic carrier particles may be within a range between, and including, any of the minimum and maximum values noted above.

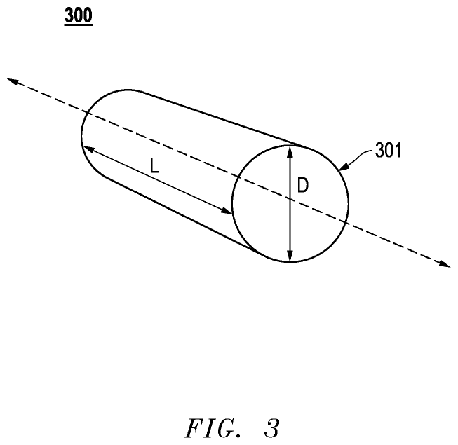

According to yet other embodiments, the batch of porous catalytic carrier particles may include a plurality of particles having a columnar shape with a particular cross-sectional shape along the length of the particle. For purposes of illustration, FIG. 3 includes an illustration of a particle 300 formed according to embodiments described herein. As shown in FIG. 3, according to certain embodiments, the particle 300 may have a circular cross-sectional shape 301 along the length of the particle. According to yet other embodiments, the plurality of particles may have an oval cross-sectional shape along the length of the particle. According to still other embodiments, the plurality of particles may have a polygonal cross-sectional shape along the length of the particle.

According to still other embodiments, the particles in the batch of porous catalytic carrier particles, which has a columnar shape, may have basic dimensions including length (L), cross-sectional diameter (D) and aspect ratio (AR). For purposes of embodiments described herein, FIG. 3 includes an illustration showing the length (L) of a particle, which is defined as the greatest dimension perpendicular to the cross-sectional shape 301 of the particle. FIG. 3 also includes an illustration showing the cross-sectional diameter (D), which is defined as the greatest dimension of the cross-sectional shape of the particle. For purposes of embodiments described herein, the aspect ratio (AR) of particles in the batch of porous catalytic carrier particles is equal to the length (L) of a particle in the batch of porous catalytic carrier particles divided by the cross-sectional diameter (D) of the particle in the batch of porous catalytic carrier particles.

It will be appreciated that all measurements, including average length (L), average cross-sectional diameter (i.e. equivalent diameter) (D), and average particle aspect ratio (AR), of a particular batch of porous catalytic carrier particles are measured using a Malvern Morphologi G3S particle size and shape analyzer. A sample of particles is placed on a 180 mm×110 mm glass plate. The particles are spread into an even monolayer such that no individual particle is in contact with another. The analyzer collects images of the particles at magnification of ×2.5 and the Morphologi software (version 8.11) then calculates different morphological properties for each particle including the length and equivalent diameter. The average length (L), average cross-sectional diameter (D), and average aspect ratio (AR) are calculated based on images taken of at least 50 particles from a particular batch of porous catalytic carrier particles. In particular, the average cross-sectional diameter (D) is calculated from particles in top-view orientation, i.e. with circular cross-section facing up. The average length (L) and average aspect ratio (AR) are calculated from particles in side-view position. For the determination of aspect ratio, length and diameter are both measured in side-view orientation, and the ratio of these dimensions is calculated.

It will be further appreciated that all particle size measurements (i.e. D, L and AR) may be described herein in combination with D-Values (i.e. D₁₀, D₅₀ and D₉₀), which may be understood to represent the distribution intercepts for 10%, 50% and 90% of the cumulative mass of a particular batch of porous catalytic carrier particles. For example, a particular batch of particles may have a Diameter D₁₀ value (i.e. DD₁₀) defined as the diameter at which 10% of the particles of the sample are comprised of particles with a diameter less than this value, a particular batch of particles may have a Diameter D₅₀ value (i.e. DD₅₀) defined as the diameter at which 50% of the particles of the sample are comprised of particles with a diameter less than this value, and a particular batch of particles may have a Diameter D₉₀ value (i.e. DD₉₀) defined as the diameter at which 90% of the particles of the sample are comprised of particles with a diameter less than this value. Further, a particular batch of particles may have a Length D₁₀ value (i.e. LD₁₀) defined as the length at which 10% of the particles of the sample are comprised of particles with a length less than this value, a particular batch of particles may have a Length D₅₀ value (i.e. LD₅₀) defined as the length at which 50% of the particles of the sample are comprised of particles with a length less than this value, and a particular batch of particles may have a Length D₉₀ value (i.e. LD₉₀) defined as the length at which 90% of the particles of the sample are comprised of particles with a length less than this value. Finally, a particular batch of particles may have a Aspect Ratio D₁₀ value (i.e. ARD₁₀) defined as the aspect ratio at which 10% of the particles of the sample are comprised of particles with a aspect ratio less than this value, a particular batch of particles may have a Aspect Ratio D₅₀ value (i.e. ARD₅₀) defined as the aspect ratio at which 50% of the particles of the sample are comprised of particles with a aspect ratio less than this value, and a particular batch of particles may have a Aspect Ratio D₉₀ value (i.e. ARD₉₀) defined as the aspect ratio at which 90% of the particles of the sample are comprised of particles with a aspect ratio less than this value.

According to still other embodiments, the batch of porous catalytic carrier particles may have a particular length (L) distribution span PLDS, where PLDS is equal to (LD₉₀−LD₁₀)/LD₅₀, where LD₉₀ is equal to a LD₉₀ particle length (L) distribution measurement of the batch of porous catalytic carrier particles, LD₁₀ is equal to a LD₁₀ particle length (L) distribution measurement. According to certain embodiments, the batch of porous catalytic carrier particles may have a length (L) distribution span PLDS of not greater than about 50%, such as, not greater than about 48% or not greater than about 45% or not greater than about 43% or not greater than about 40% or not greater than about 38% or not greater than about 35% or not greater than about 33% or even not greater than about 30%. It will be appreciated that the length (L) distribution span PLDS of the batch of porous catalytic carrier particles may be any value between, and including, any of the minimum and maximum values noted above. It will be further appreciated that the length (L) distribution span PLDS of the batch of porous catalytic carrier particles may be within a range between, and including, any of the minimum and maximum values noted above.

According to still other embodiments, the batch of porous catalytic carrier particles may have a particular diameter (D) distribution span PDDS, where PDDS is equal to (DD₉₀−DD₁₀)/DD₅₀, where DD₉₀ is equal to a DD₉₀ particle diameter (D) distribution measurement of the batch of porous catalytic carrier particles, DD₁₀ is equal to a DD₁₀ particle diameter (D) distribution measurement. According to certain embodiments, the batch of porous catalytic carrier particles may have a diameter (D) distribution span PDDS of not greater than about 50%, such as, not greater than about 48% or not greater than about 45% or not greater than about 43% or not greater than about 40% or not greater than about 38% or not greater than about 35% or not greater than about 33% or even not greater than about 30%. It will be appreciated that the diameter (D) distribution span PDDS of the batch of porous catalytic carrier particles may be any value between, and including, any of the minimum and maximum values noted above. It will be further appreciated that the diameter (D) distribution span PDDS of the batch of porous catalytic carrier particles may be within a range between, and including, any of the minimum and maximum values noted above.

According to still other embodiments, the batch of porous catalytic carrier particles may have a particular aspect ratio (AR) distribution span PARDS, where PARDS is equal to (ARD₉₀−ARD₁₀)/ARD₅₀, where ARD₉₀ is equal to a ARD₉₀ particle aspect ratio (AR) distribution measurement of the batch of porous catalytic carrier particles, ARD₁₀ is equal to a ARD₁₀ particle aspect ratio (AR) distribution measurement. According to certain embodiments, the batch of porous catalytic carrier particles may have an aspect ratio (AR) distribution span PARDS of not greater than about 50%, such as, not greater than about 48% or not greater than about 45% or not greater than about 43% or not greater than about 40% or not greater than about 38% or not greater than about 35% or not greater than about 33% or even not greater than about 30%. It will be appreciated that the aspect ratio (AR) distribution span PARDS of the batch of porous catalytic carrier particles may be any value between, and including, any of the minimum and maximum values noted above. It will be further appreciated that the aspect ratio (AR) distribution span PARDS of the batch of porous catalytic carrier particles may be within a range between, and including, any of the minimum and maximum values noted above.

According to yet other embodiments, the batch of porous catalytic carrier particles may have a particular average particle cross-sectional diameter (D). According to certain embodiments, the batch of porous catalytic carrier particles may have an average cross-sectional diameter of not greater than about 5.0 mm, such as, not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or not greater than about 2.2 mm or not greater than about 2.1 mm or not greater than about 2.0 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or even not greater than about 0.5 mm. According to still other embodiments, the batch of porous catalytic carrier particles may have an average cross-sectional diameter of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm. It will be appreciated that the average cross-sectional diameter of the batch of porous catalytic carrier particles may be any value between, and including, any of the minimum and maximum values noted above. It will be further appreciated that the average cross-sectional diameter of the batch of porous catalytic carrier particles may be within a range between, and including, any of the minimum and maximum values noted above.

According to still other embodiments, the batch of porous catalytic carrier particles may have a particular average length (L). According to certain embodiments, the batch of porous catalytic carrier particles may have an average particle length of at least about 0.001 mm, such as, at least about 0.005 mm or at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or even at least about 0.3 mm. According to yet other embodiments, the batch of porous catalytic carrier particles may have an average particle length of not greater than about 10 mm, such as, not greater than about 9 mm or not greater than about 8 mm or not greater than about 7 mm or not greater than about 6 mm or not greater than about 5 mm or not greater than about 4 mm or not greater than about 3 mm or not greater than about 2 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1. It will be appreciated that the average length of the batch of porous catalytic carrier particles may be any value between, and including, any of the minimum and maximum values noted above. It will be further appreciated that the average length of the batch of porous catalytic carrier particles may be within a range between, and including, any of the minimum and maximum values noted above.

According to yet other embodiments, the batch of porous catalytic carrier particles may have a particular average aspect ratio (AR). According to certain embodiments, the batch of porous catalytic carrier particles may have an average aspect ratio (AR) of not greater than about 5, such as, not greater than about 4.5 or not greater than about 4.0 or not greater than about 3.5 or not greater than about 3.0 or not greater than about 2.5 or not greater than about 2.0 or not greater than about 1.9 or not greater than about 1.8 or not greater than about 1.7 or not greater than about 1.6 or not greater than about 1.5 or not greater than about 1.4 or not greater than about 1.3 or not greater than about 1.2 or not greater than about 1.1 or not greater than about 0.9 or not greater than about 0.8 or not greater than about 0.7 or not greater than about 0.6 or even not greater than about 0.5. According to still other embodiments, the batch of porous catalytic carrier particles may have an average aspect ratio (AR) of at least about 0.1, such as, at least about 0.2 or even at least about 0.3. It will be appreciated that the average aspect ratio (AR) of the batch of porous catalytic carrier particles may be any value between, and including, any of the minimum and maximum values noted above. It will be further appreciated that the average aspect ratio (AR) of the batch of porous catalytic carrier particles may be within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of forming a batch of porous catalytic carrier particles, wherein the method comprises: applying a precursor mixture into a shaping assembly within an application zone to form a batch of precursor porous catalytic carrier particles; drying the batch of precursor porous catalytic carrier particles within the shaping assembly to form a batch of greenware porous catalytic carrier particles; directing an ejection material at the shaping assembly under a predetermined force to remove the batch of greenware porous catalytic carrier particles from the shaping assembly, and firing (i.e. calcining) the batch of greenware porous catalytic carrier particles to form the batch of porous catalytic carrier particles, wherein the batch of porous catalytic carrier particles comprises an average pore volume of at least about 0.1 cm³/g.

Embodiment 2. A method of forming a batch of porous catalytic carrier particles, wherein the method comprises: applying a precursor mixture into a shaping assembly within an application zone to form a batch of precursor porous catalytic carrier particles; drying the batch of precursor porous catalytic carrier particles within the shaping assembly to form a batch of greenware porous catalytic carrier particles; directing an ejection material at the shaping assembly under a predetermined force to remove the batch of greenware porous catalytic carrier particles from the shaping assembly, and firing (i.e. calcining) the batch of greenware porous catalytic carrier particles to form the batch of porous catalytic carrier particles, wherein the batch of porous catalytic carrier particles comprises an average specific surface area of at least about 0.1 m²/g.

Embodiment 3. A method of forming a batch of porous catalytic carrier particles, wherein the method comprises: applying a precursor mixture into a shaping assembly within an application zone to form a batch of precursor porous catalytic carrier particles; drying the batch of precursor porous catalytic carrier particles within the shaping assembly to form a batch of greenware porous catalytic carrier particles; directing an ejection material at the shaping assembly under a predetermined force to remove the batch of porous catalytic carrier particles from the shaping assembly, and firing (i.e. calcining) the batch of greenware porous catalytic carrier particles to form the batch of porous catalytic carrier particles, wherein the batch of porous catalytic carrier particles comprises an average packing density of not greater than about 1.9 g/cm³.

Embodiment 4. The method of any one of embodiments 1, 2, and 3, wherein applying the precursor mixture into a shaping assembly comprises extruding the precursor mixture through a die opening and into the shaping assembly, wherein the shaping assembly comprises an opening configured to receive the precursor mixture, wherein the opening is defined by at least three surfaces, wherein the opening extends through an entire thickness of a first portion of the shaping assembly, wherein the opening extends through an entire thickness of the shaping assembly, wherein the opening extends through a portion of an entire thickness of the shaping assembly.

Embodiment 5. The method of any one of embodiments 1, 2, and 3, wherein the shaping assembly comprises a screen, wherein the shaping assembly comprises a mold, wherein the shaping assembly comprises a first portion comprising a screen, wherein the shaping assembly comprises a second portion comprising a backing plate, wherein the first portion and the second portion are adjacent to each other in the application zone, wherein the first portion is abutting the second portion in the application zone, wherein the screen is adjacent the backing plate in the application zone, wherein the backing plate is abutting the screen within the application zone, wherein a surface of the backing plate is configured to contact the mixture in the opening of the screen.

Embodiment 6. The method of any one of embodiments 1, 2, and 3, wherein the first portion is translated relative to a die opening in the application zone, wherein the first portion is translated relative to the second portion of the shaping assembly in the application zone, wherein the first portion is translated relative to a direction of extrusion in the application zone, wherein the angle between the direction of translation of the screen and the direction of extrusion is acute, wherein the angle is obtuse, wherein the angle is substantially orthogonal.

Embodiment 7. The method of any one of embodiments 1, 2, and 3, wherein at least a portion of the shaping assembly is translated through the application zone, wherein at least a first portion of the shaping assembly is translated through the application zone, wherein the portion of the shaping assembly is translated at a rate of at least about 0.5 mm/sec, at least about 1 cm/sec, at least about 8 cm/sec, and not greater than about 5 m/sec.

Embodiment 8. The method of any one of embodiments 1, 2, and 3, wherein applying the mixture comprises depositing the mixture through a process selected from the group consisting of extrusion, printing, spraying, and a combination thereof wherein the mixture is extruded through a die opening and into an opening in the shaping assembly, wherein during extrusion into the opening, the mixture flows into a first portion of the shaping assembly and abuts a surface of a second portion of the shaping assembly.

Embodiment 9. The method of any one of embodiments 1, 2, and 3, further comprising translating at least a portion of the shaping assembly from the application zone to an ejection zone, wherein the shaping assembly comprises a backing plate, and the backing plate is removed in the ejection zone, wherein the backing plate terminates prior to the ejection zone, wherein opposing major surfaces of the mixture are exposed in an opening of a portion of the shaping assembly in the ejection zone.

Embodiment 10. The method of any one of embodiments 1, 2, and 3, further comprising separating a first portion of the shaping assembly from a second portion of the shaping assembly, further comprising removing the greenware porous catalytic carrier particles from at least one surface of a portion of the shaping assembly prior to removing the greenware porous catalytic carrier particles from the shaping assembly, further comprising removing a backing plate defining a second portion of the shaping assembly from a first portion of the shaping assembly, and removing the greenware porous catalytic carrier particles from an opening in a second portion of the shaping assembly after removing the backing plate.

Embodiment 11. The method of any one of embodiments 1, 2, and 3, wherein the ejection material directly contacts an exposed major surface of the greenware porous catalytic carrier particles in an opening of the shaping assembly, wherein the ejection material directly contacts an exposed major surface of the greenware porous catalytic carrier particles and a portion of the shaping assembly.

Embodiment 12. The method of any one of embodiments 1, 2, and 3, wherein the precursor mixture comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

Embodiment 13. The method of any one of embodiments 1, 2, and 3, wherein the batch of porous catalytic carrier particles comprises alumina, silica, titania, zirconia, magnesia, silicon carbide, carbon, zeolites, metal organic frameworks (MOFs), spinels, perovskites, and combinations thereof.

Embodiment 14. The method of any one of embodiments 1, 2, and 3, wherein the batch of porous catalytic carrier particles comprise an average pore volume of at least about 0.1 cm³/g or at least about 0.15 cm³/g or at least about 0.2 cm³/g or at least about 0.25 cm³/g or at least about 0.3 cm³/g cm³/g or at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or at least about 0.8 cm³/g.

Embodiment 15. The method of any one of embodiments 1, 2, and 3, wherein the batch of porous catalytic carrier particles comprise an average pore volume of not greater than about 10 cm³/g or not greater than about 9 cm³/g or not greater than about 8 cm/g or not greater than about 7 cm³/g or not greater than about 6 cm³/g or not greater than about 5 cm³/g.

Embodiment 16. The method of any one of embodiments 1, 2, and 3, wherein the batch of porous catalytic carrier particles comprise an average specific surface area of at least about 0.1 m²/g or at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or at least about 200 m²/g.

Embodiment 17. The method of any one of embodiments 1, 2, and 3, wherein the batch of porous catalytic carrier particles comprise an average specific surface area of not greater than about 2000 m²/g or not greater than about 1500 m²/g or not greater than about 1000 m²/g or not greater than about 500 m²/g or not greater than about 400 m²/g or not greater than about 300 m²/g.

Embodiment 18. The method of any one of embodiments 1, 2, and 3, wherein the batch of porous catalytic carrier particles comprise an average packing density of not greater than about 1.9 g/cm³ or not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/m³ or not greater than about 1.1 g/cm³ or not greater than about 1.05 g/cm³ or not greater than about 1.0 g/cm³.

Embodiment 19. The method of any one of embodiments 1, 2, and 3, wherein the batch of porous catalytic carrier particles comprise an average packing density of at least about 0.1 g/cm³.

Embodiment 20. The method of any one of embodiments 1, 2, and 3, wherein the batch of porous catalytic carrier particles comprise a Geopycnometer density of at least about 0.1 g/cm³.

Embodiment 21. The method of any one of embodiments 1, 2, and 3, wherein the batch of porous catalytic carrier particles comprise a Geopycnometer density of not greater than about 5.0 g/cm³.

Embodiment 22. The method of any one of embodiments 1, 2, and 3, wherein the batch of porous catalytic carrier particles comprises a plurality of particles having a columnar shape.

Embodiment 23. The method of any one of embodiments 1, 2, and 3, wherein the batch of porous catalytic carrier particles comprises a plurality of particles having a circular cross-sectional shape.

Embodiment 24. The method of any one of embodiments 1, 2, and 3, wherein the batch of porous catalytic carrier particles comprises a plurality of particles having an oval cross-sectional shape.

Embodiment 25. The method of any one of embodiments 1, 2, and 3, wherein the batch of porous catalytic carrier particles comprises a plurality of particles having a polygonal cross-sectional shape.

Embodiment 26. The method of any one of embodiments 1, 2, and 3, wherein the batch of porous catalytic carrier particles has an average particle diameter of not greater than about 5.0 mm and a particle aspect ratio (L/D) distribution span PARDS of not greater than about 50%, where PARDS is equal to (ARD₉₀−ARD₁₀)/ARD₅₀, where ARD₉₀ is equal to a ARD₉₀ particle aspect ratio (L/D) distribution measurement of the batch of porous catalytic carrier particles, ARD₁₀ is equal to a ARD₁₀ particle aspect ratio (L/D) distribution measurement.

Embodiment 27. The method of any one of embodiments 1, 2, and 3, wherein the batch of porous catalytic carrier particles has an average particle diameter of not greater than about 5.0 mm, such as, not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or not greater than about 2.2 mm or not greater than about 2.1 mm or not greater than about 2.0 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm.

Embodiment 28. The method of any one of embodiments 1, 2, and 3, wherein the batch of porous catalytic carrier particles has an average particle diameter of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm.

Embodiment 29. The method of any one of embodiments 1, 2, and 3, the batch of porous catalytic carrier particles has an average particle length of at least about 0.001 or at least about 0.005 or at least about 0.01 m or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 03 mm.

Embodiment 30. The method of any one of embodiments 1, 2, and 3, wherein the batch of porous catalytic carrier particles has an average particle length of not greater than about 10 mm or not greater than about 9 mm or not greater than about 8 mm or not greater than about 7 mm or not greater than about 6 mm or not greater than about 5 mm or not greater than about 4 mm or not greater than about 3 mm or not greater than about 2 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1.

Embodiment 31. The method of any one of embodiments 1, 2, and 3, wherein the batch of porous catalytic carrier particles has an average aspect ratio (L/D) of not greater than about 5 or not greater than about 4.5 or not greater than about 4.0 or not greater than about 3.5 or not greater than about 3.0 or not greater than about 2.5 or not greater than about 2.0 or not greater than about 1.9 or not greater than about 1.8 or not greater than about 1.7 or not greater than about 1.6 or not greater than about 1.5 or not greater than about 1.4 or not greater than about 1.3 or not greater than about 1.2 or not greater than about 1.1 or not greater than about 0.9 or not greater than about 0.8 or not greater than about 0.7 or not greater than about 0.6 or not greater than about 0.5.

Embodiment 32. The method of any one of embodiments 1, 2, and 3, wherein the batch of porous catalytic carrier particles has an average aspect ratio (L/D) of at least about 0.1 or at least about 0.2 or at least about 0.3.

Embodiment 33. A batch of porous catalytic carrier particles comprising an average particle diameter of not greater than about 5.0 mm and a particle aspect ratio (L/D) distribution span PARDS of not greater than about 50%, where PARDS is equal to (ARD₉₀−ARD₁₀)/ARD₅₀, where ARD₉₀ is equal to a ARD₉₀ particle aspect ratio (LID) distribution measurement of the batch of porous catalytic carrier particles, ARD₁₀ is equal to a ARD₁₀ particle aspect ratio (L/D) distribution measurement.

Embodiment 34. The batch of porous catalytic carrier particles of embodiment 33, wherein the batch of porous catalytic carrier particles comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

Embodiment 35. The batch of porous catalytic carrier particles of embodiment 33, wherein the batch of porous catalytic carrier particles comprise an average pore volume of at least about 0.1 cm³/g, such as, at least about 0.15 cm³/g or at least about 0.2 cm³/g or at least about 0.25 cm³/g or at least about 0.3 cm³/g or at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or at least about 0.8 cm³/g.

Embodiment 36. The batch of porous catalytic carrier particles of embodiment 33, wherein the batch of porous catalytic carrier particles comprise an average pore volume of not greater than about 10 cm³/g or not greater than about 9 cm³/g or not greater than about 8 cm³/g or not greater than about 7 cm³/g or not greater than about 6 cm³/g or not greater than about 5 cm³/g.

Embodiment 37. The batch of porous catalytic carrier particles of embodiment 33, wherein the batch of porous catalytic carrier particles comprise an average specific surface area of at least about 0.1 m/g or at least about 1.0 m²/g or at least about 5 m/g or at least about 10 m²/g or at least about 25 m²/g or at least about 50 m²/g or at least about 75 m²/g or at least about 100 m²/g or at least about 125 m/g or at least about 150 m²/g or at least about 175 m²/g or at least about 200 m²/g.

Embodiment 38. The batch of porous catalytic carrier particles of embodiment 33, wherein the batch of porous catalytic carrier particles comprise an average specific surface area of not greater than about 2000 m²/g or not greater than about 1500 m²/g or not greater than about 1000 m²/g or not greater than about 500 m²/g or not greater than about 400 m²/g or not greater than about 300 m²/g.

Embodiment 39. The batch of porous catalytic carrier particles of embodiment 33, wherein the batch of porous catalytic carrier particles comprise an average packing density of not greater than about 1.9 g/cm³ or not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or not greater than about 1.0 g/cm³.

Embodiment 40. The batch of porous catalytic carrier particles of embodiment 33, wherein the batch of porous catalytic carrier particles comprise an average packing density of at least about 0.1 g/cm³.

Embodiment 41. The batch of porous catalytic carrier particles of embodiment 33, wherein the batch of porous catalytic carrier particles comprise a Geopycnometer density of at least about 0.1 g/cm³.

Embodiment 42. The batch of porous catalytic carrier particles of embodiment 33, wherein the batch of porous catalytic carrier particles comprise a Geopycnometer density of not greater than about 5.0 g/cm³.

Embodiment 43. The batch of porous catalytic carrier particles of embodiment 33, wherein the batch of porous catalytic carrier particles comprise a plurality of particles having a columnar shape.

Embodiment 44. The batch of porous catalytic carrier particles of embodiment 33, wherein the batch of porous catalytic carrier particles comprise a plurality of particles having a circular cross-sectional shape.

Embodiment 45. The batch of porous catalytic carrier particles of embodiment 33, wherein the batch of porous catalytic carrier particles comprise a plurality of particles having an oval cross-sectional shape.

Embodiment 46. The batch of porous catalytic carrier particles of embodiment 33, wherein the batch of porous catalytic carrier particles comprise a plurality of particles having a polygonal cross-sectional shape.

Embodiment 47. The batch of porous catalytic carrier particles of embodiment 33, wherein the batch of porous catalytic carrier particles has an average particle diameter of not greater than about 5.0 mm and a particle aspect ratio (JD) distribution span PARDS of not greater than about 50%, where PARDS is equal to (ARD₉₀−ARD₁₀)/ARD₅₀, where ARD₉₀ is equal to a ARD₉₀ particle aspect ratio (L/D) distribution measurement of the batch of porous catalytic carrier particles, ARD₁₀ is equal to a ARD₁₀ particle aspect ratio (L/D) distribution measurement.

Embodiment 48. The batch of porous catalytic carrier particles of embodiment 33, wherein the batch of porous catalytic carrier particles has an average particle diameter of not greater than about 5.0 mm, such as, not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.3 mm or not greater than about 2.2 mm or not greater than about 2.1 mm or not greater than about 2.0 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm.

Embodiment 49. The batch of porous catalytic carrier particles of embodiment 33, wherein the batch of porous catalytic carrier particles has an average particle diameter of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm.

Embodiment 50. The batch of porous catalytic carrier particles of embodiment 33, the batch of porous catalytic carrier particles has an average particle length of at least about 0.001 or at least about 0.005 or at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm.

Embodiment 51. The batch of porous catalytic carrier particles of embodiment 33, wherein the batch of porous catalytic carrier particles has an average particle length of not greater than about 10 mm or not greater than about 9 mm or not greater than about 8 mm or not greater than about 7 mm or not greater than about 6 mm or not greater than about 5 mm or not greater than about 4 mm or not greater than about 3 mm or not greater than about 2 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1.

Embodiment 52. The batch of porous catalytic carrier particles of embodiment 33, wherein the batch of porous catalytic carrier particles has an average aspect ratio (LID) of not greater than about 5 or not greater than about 4.5 or not greater than about 4.0 or not greater than about 3.5 or not greater than about 3.0 or not greater than about 2.5 or not greater than about 2.0 or not greater than about 1.9 or not greater than about 1.8 or not greater than about 1.7 or not greater than about 1.6 or not greater than about 1.5 or not greater than about 1.4 or not greater than about 1.3 or not greater than about 1.2 or not greater than about 1.1 or not greater than about 0.9 or not greater than about 0.8 or not greater than about 0.7 or not greater than about 0.6 or not greater than about 0.5.

Embodiment 53. The batch of porous catalytic carrier particles of embodiment 33, wherein the batch of porous catalytic carrier particles has an average aspect ratio (LID) of at least about 0.1 or at least about 0.2 or at least about 0.3.

Embodiment 54. A system for forming a batch of porous catalytic carrier particles, wherein the system comprises: an application zone comprising a shaping assembly including a first portion having an opening and configured to be filled with a precursor mixture to form a batch of precursor porous catalytic carrier particles, and a second portion abutting the first portion; a drying zone comprising a first heat source and being configured to dry the batch of precursor porous catalytic carrier particles to form the batch of porous catalytic carrier particles; and an ejection zone comprising an ejection assembly configured to direct an ejection material toward the opening in the first portion of the shaping assembly to remove the batch of porous catalytic carrier particles from the shaping assembly.

Embodiment 55. The system of embodiment 54, wherein the precursor mixture comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

Embodiment 56. The system of embodiment 54, wherein the batch of porous catalytic carrier particles comprises alumina, silica, titania, zirconia, magnesia, silicon carbide, carbon, zeolites, metal organic frameworks (MOFs), spinels, perovskites, and combinations thereof.

Embodiment 57. The system of embodiment 54, wherein the batch of porous catalytic carrier particles comprise an average pore volume of at least about 0.1 cm³/g or at least about 0.15 cm³/g or at least about 0.2 cm³/g or at least about 0.25 cm³/g or at least about 0.3 cm³/g or at least about 0.35 cm³/g or at least about 0.4 cm³/g or at least about 0.45 cm³/g or at least about 0.5 cm³/g or at least about 0.55 cm³/g or at least about 0.6 cm³/g or at least about 0.65 cm³/g or at least about 0.7 cm³/g or at least about 0.75 cm³/g or at least about 0.8 cm³/g.

Embodiment 58. The system of embodiment 54, wherein the batch of porous catalytic carrier particles comprise an average pore volume of not greater than about 10 cm³/g or not greater than about 9 cm³/g or not greater than about 8 cm³/g or not greater than about 7 cm³/g or not greater than about 6 cm³/g or not greater than about 5 cm³/g.

Embodiment 59. The system of embodiment 54, wherein the batch of porous catalytic carrier particles comprise an average specific surface area of at least about 0.1 m²/g or at least about 1.0 m²/g or at least about 5 m²/g or at least about 10 m²/g or at least about 25 m²/g or at least about 50 m²/g or at least about 75 m²/g or at least about 100 m²/g or at least about 125 m²/g or at least about 150 m²/g or at least about 175 m²/g or at least about 200 m²/g.

Embodiment 60. The system of embodiment 54, wherein the batch of porous catalytic carrier particles comprise an average specific surface area of not greater than about 2000 m²/g or not greater than about 1500 m²/g or not greater than about 1000 m/g or not greater than about 500 m²/g or not greater than about 400 m²/g or not greater than about 300 m²/g.

Embodiment 61. The system of embodiment 54, wherein the batch of porous catalytic carrier particles comprise an average packing density of not greater than about 1.9 g/cm³ or not greater than about 1.85 g/cm³ or not greater than about 1.8 g/cm³ or not greater than about 1.75 g/cm³ or not greater than about 1.7 g/cm³ or not greater than about 1.65 g/cm³ or not greater than about 1.6 g/cm³ or not greater than about 1.55 g/cm³ or not greater than about 1.5 g/cm³ or not greater than about 1.45 g/cm³ or not greater than about 1.4 g/cm³ or not greater than about 1.35 g/cm³ or not greater than about 1.3 g/cm³ or not greater than about 1.25 g/cm³ or not greater than about 1.2 g/cm³ or not greater than about 1.15 g/cm³ or not greater than about 1.1 g/cm³ or not greater than about 1.05 g/cm³ or not greater than about 1.0 g/cm³.

Embodiment 62. The system of embodiment 54, wherein the batch of porous catalytic carrier particles comprise an average packing density of at least about 0.1 g/cm³.

Embodiment 63. The system of embodiment 54, wherein the batch of porous catalytic carrier particles comprise a Geopycnometer density of at least about 0.1 g/cm³.

Embodiment 64. The system of embodiment 54, wherein the batch of porous catalytic carrier particles comprise a Geopycnometer density of not greater than about 5.0 g/cm³.

Embodiment 65. The system of embodiment 54, wherein the batch of porous catalytic carrier particles comprise a plurality of particles having a columnar shape.

Embodiment 66. The system of embodiment 54, wherein the batch of porous catalytic carrier particles comprise a plurality of particles having a circular cross-sectional shape.

Embodiment 67. The system of embodiment 54, wherein the batch of porous catalytic carrier particles comprise a plurality of particles having an oval cross-sectional shape.

Embodiment 68. The system of embodiment 54, wherein the batch of porous catalytic carrier particles comprise a plurality of particles having a polygonal cross-sectional shape.

Embodiment 69. The system of embodiment 54, wherein the batch of porous catalytic carrier particles has an average particle diameter of not greater than about 5.0 mm and a particle aspect ratio (L/D) distribution span PARDS of not greater than about 50%, where PARDS is equal to (ARD₉₀−ARD₁₀)/ARD₅₀, where ARD₉₀ is equal to a ARD₉₀ particle aspect ratio (L/D) distribution measurement of the batch of porous catalytic carrier particles, ARD₁₀ is equal to a ARD₁₀ particle aspect ratio (L/D) distribution measurement.

Embodiment 70. The system of embodiment 54, wherein the batch of porous catalytic carrier particles has an average particle diameter of not greater than about 5.0 mm, such as, not greater than about 4.5 mm or not greater than about 4.0 mm or not greater than about 3.5 mm or not greater than about 3.0 mm or not greater than about 2.9 mm or not greater than about 2.8 mm or not greater than about 2.7 mm or not greater than about 2.6 mm or not greater than about 2.5 mm or not greater than about 2.4 mm or not greater than about 2.31 mm or not greater than about 2.2 mm or not greater than about 2.1 mm or not greater than about 2.0 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm.

Embodiment 71. The system of embodiment 54, wherein the batch of porous catalytic carrier particles has an average particle diameter of at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm.

Embodiment 72. The system of embodiment 54, the batch of porous catalytic carrier particles has an average particle length of at least about 0.001 or at least about 0.005 or at least about 0.01 mm or at least about 0.02 mm or at least about 0.03 mm or at least about 0.04 mm or at least about 0.05 mm or at least about 0.06 mm or at least about 0.07 mm or at least about 0.08 mm or at least about 0.09 mm or at least about 0.1 mm or at least about 0.2 mm or at least about 0.3 mm.

Embodiment 73. The system of embodiment 54, wherein the batch of porous catalytic carrier particles has an average particle length of not greater than about 10 mm or not greater than about 9 mm or not greater than about 8 mm or not greater than about 7 mm or not greater than about 6 mm or not greater than about 5 mm or not greater than about 4 mm or not greater than about 3 mm or not greater than about 2 mm or not greater than about 1.9 mm or not greater than about 1.8 mm or not greater than about 1.7 mm or not greater than about 1.6 mm or not greater than about 1.5 mm or not greater than about 1.4 mm or not greater than about 1.3 mm or not greater than about 1.2 mm or not greater than about 1.1 mm or not greater than about 1.0 mm or not greater than about 0.9 mm or not greater than about 0.8 mm or not greater than about 0.7 mm or not greater than about 0.6 mm or not greater than about 0.5 mm or not greater than about 0.4 mm or not greater than about 0.3 mm or not greater than about 0.2 mm or not greater than about 0.1.

Embodiment 74. The system of embodiment 54, wherein the batch of porous catalytic carrier particles has an average aspect ratio (L/D) of not greater than about 5 or not greater than about 4.5 or not greater than about 4.0 or not greater than about 3.5 or not greater than about 3.0 or not greater than about 2.5 or not greater than about 2.0 or not greater than about 1.9 or not greater than about 1.8 or not greater than about 1.7 or not greater than about 1.6 or not greater than about 1.5 or not greater than about 1.4 or not greater than about 1.3 or not greater than about 1.2 or not greater than about 1.1 or not greater than about 0.9 or not greater than about 0.8 or not greater than about 0.7 or not greater than about 0.6 or not greater than about 0.5.

Embodiment 75. The system of embodiment 54, wherein the batch of porous catalytic carrier particles has an average aspect ratio (L/D) of at least about 0.1 or at least about 0.2 or at least about 0.3.

### EXAMPLES

### Example 1

Three sample batches of porous catalytic carrier particles S1-S3 were formed according to embodiments described herein. The sample batches of porous catalytic carrier particles S1-S3 were formed using a screen printing process according to embodiments described herein and using the parameters summarized in Table 1 below.

TABLE 1
Process Parameters for Forming Porous
Catalytic Carrier Particles S1-S3

| | S1 | | S2 | | S3 | |
|---|---|---|---|---|---|---|
| Starting Material | Boehmite 1 | | Boehmite 1 | | Boehmite 1 | |
| Forming Process | Screen Printed, | | Screen Printed, | | Screen Printed, | |
| | Dried and Fired | | Dried and Fired | | Dried and Fired | |
| Dispenser Pressure | 80 | PSI | 80 | PSI | 80 | PSI |
| Line Speed | 1.6 | m/min | 1.6 | m/min | 1.6 | m/min |

| | | | |
|---|---|---|---|
| Firing Temperature | 600 | 1000 | 1200 |
| (° C.) | | | |

Sample batches of porous catalytic carrier particles S1-S3 were measured to determine their composition and shape properties for comparison.

TABLE 2
Finished Properties/Measurements for Batch Samples S1-S3

| Properties/Measurement | S1 | S2 | S3 |
|---|---|---|---|
| Phase From XRD | γ/δ-Al₂O₃ | γ/θ-Al₂O₃ | α-Al₂O₃ |
| Specific surface area (m²/g) | 259 | 123 | 9.0 |
| Pore volume (cm³/g) | 1.15 | 1.01 | 0.69 |
| Median pore diameter (Å) | 119 | 229 | 2424 |
| Aspect Ratio D₁₀ (ARD₁₀) | 0.553 | 0.544 | 0.551 |
| Aspect Ratio D₅₀ (ARD₅₀) | 0.592 | 0.586 | 0.589 |
| Aspect Ratio D₉₀ (ARD₉₀) | 0.669 | 0.658 | 0.657 |
| PARDS (%) | 19.6 | 19.5 | 18.0 |
| Packing Density (lb/ft³) | 21.2 | 24.3 | 35.6 |
| Packing Density (g/cm³) | 0.34 | 0.39 | 0.57 |
| Geopycnometer Density (g/cm³) | 0.53 | 0.58 | 0.85 |
| Packing void volume (%) | 35.8 | 32.6 | 32.6 |

All dimensional measurements, including average diameter (D) and average aspect ratio (AR), of a particular batch of porous catalytic carrier particles, were measured using a Malvern Morphologi G3 particle size and shape analyzer. A sample of particles is placed on a 180 mm×110 mm glass plate and spread into an even monolayer such that no individual particle is in contact with another. The particles are oriented sideways as depicted in the image below. The analyzer takes images of the particles and the software then calculates different morphological properties for each particle including the length (L) and equivalent diameter (D). Aspect ratio is calculated by the software as length divided by diameter (AR=L/D). The average measurements and calculations are based on images taken of at least 50 particles from a particular batch of porous catalytic carrier particles.

### Example 2

Three sample batches of porous catalytic carrier particles S4-S6 were formed according to embodiments described herein. The sample batches of porous catalytic carrier particles S4-S6 were formed using a screen printing process according to embodiments described herein and using the parameters summarized in Table 3 below.

TABLE 3
Process Parameters for Forming Porous
Catalytic Carrier Particles S4-S6

| | S4 | | S5 | | S6 | |
|---|---|---|---|---|---|---|
| Starting Material | Boehmite 2 | | Boehmite 2 | | Boehmite 2 | |
| Forming Process | Screen Printed, | | Screen Printed, | | Screen Printed, | |
| | Dried and Fired | | Dried and Fired | | Dried and Fired | |
| Dispenser Pressure | 80 | PSI | 80 | PSI | 80 | PSI |
| Line Speed | 1.6 | m/min | 1.6 | m/min | 1.6 | m/min |

| | | | |
|---|---|---|---|
| Firing Temperature | 600 | 1000 | 1200 |
| (° C.) | | | |

Sample batches of porous catalytic carrier particles S4-S6 were measured to determine their composition and shape properties for comparison.

TABLE 4
Finished Properties/Measurements for Batch Samples S4-S6

| Properties/Measurement | S4 | S5 | S6 |
|---|---|---|---|
| Phase From XRD | γ-Al₂O₃ | γ/θ-Al₂O₃ | γ/θ/α-Al₂O₃ |
| Specific surface area (m²/g) | 253 | 123 | 6.3 |
| Pore volume (cm³/g) | 0.63 | 0.50 | 0.25 |
| Median pore diameter (Å) | 69 | 98 | 910 |
| Aspect Ratio D₁₀ (ARD₁₀) | 0.527 | 0.524 | 0.524 |
| Aspect Ratio D₅₀ (ARD₅₀) | 0.565 | 0.572 | 0.569 |
| Aspect Ratio D₉₀ (ARD₉₀) | 0.654 | 0.666 | 0.672 |
| PARDS (%) | 22.5 | 24.8 | 26.0 |
| Packing Density (lb/ft³) | 34.3 | 38.7 | 62.4 |
| Packing Density (g/cm³) | 0.55 | 0.62 | 1.00 |
| Geopycnometer Density (g/cm³) | 0.88 | 1.04 | 1.65 |
| Packing void volume (%) | 37.5 | 40.4 | 39.2 |

All dimensional measurements, including average diameter (D) and average aspect ratio (AR), of a particular batch of porous catalytic carrier particles, were measured using a Malvern Morphologi G3 particle size and shape analyzer. A sample of particles is placed on a 180 mm×110 mm glass plate and spread into an even monolayer such that no individual particle is in contact with another. The particles are oriented sideways as depicted in the image below. The analyzer takes images of the particles and the software then calculates different morphological properties for each particle including the length (L) and equivalent diameter (D). Aspect ratio is calculated by the software as length divided by diameter (AR=L/D). The average measurements and calculations are based on images taken of at least 50 particles from a particular batch of porous catalytic carrier particles.

### Example 3

Three sample batches of porous catalytic carrier particle S7-S9 were formed according to embodiments described herein. The sample batches of porous catalytic carrier particles S7-S9 were formed using a screen printing process according to embodiments described herein and using the parameters summarized in Table 5 below.

TABLE 5
Process Parameters for Forming Porous
Catalytic Carrier Particles S7-S9

| | S7 | | S8 | | S9 | |
|---|---|---|---|---|---|---|
| Starting Material | Silica | | Silica | | Silica | |
| Forming Process | Screen Printed, | | Screen Printed, | | Screen Printed, | |
| | Dried and Fired | | Dried and Fired | | Dried and Fired | |
| Dispenser Pressure | 80 | PSI | 80 | PSI | 80 | PSI |
| Line Speed | 1.6 | m/min | 1.6 | m/min | 1.6 | m/min |

| | | | |
|---|---|---|---|
| Firing Temperature | 750 | 825 | 900 |
| (° C.) | | | |

Sample batches of porous catalytic carrier particles S7-S9 were measured to determine their composition and shape properties for comparison.

TABLE 6
Finished Properties/Measurements for Batch Samples S7-S9

| Properties/Measurement | S7 | S8 | S9 |
|---|---|---|---|
| Phase From XRD | Amorphous | Amorphous | Amorphous |
| Specific surface area (m²/g) | 227 | 218 | 200 |
| Pore volume (cm³/g) | 1.08 | 0.88 | 0.87 |
| Median pore diameter (Å) | 117 | 115 | 116 |
| Aspect Ratio (AR₁₀) | 0.544 | 0.550 | 0.536 |
| Aspect Ratio (AR₅₀) | 0.592 | 0.590 | 0.581 |
| Aspect Ratio (AR₉₀) | 0.654 | 0.667 | 0.665 |
| PARDS (%) | 18.6 | 19.8 | 22.2 |
| Packing Density (lb/ft³) | 21.9 | 21.9 | 24.3 |
| Packing Density (g/cm³) | 0.35 | 0.35 | 0.39 |
| Geopycnometer (g/cm³) | 0.56 | 0.54 | 0.62 |
| Packing void volume (%) | 37.9 | 35.0 | 36.8 |

All dimensional measurements, including average diameter (D) and average aspect ratio (AR), of a particular batch of porous catalytic carrier particles, were measured using a Malvern Morphologi G3 particle size and shape analyzer. A sample of particles is placed on a 180 mm×110 mm glass plate and spread into an even monolayer such that no individual particle is in contact with another. The particles are oriented sideways as depicted in the image below. The analyzer takes images of the particles and the software then calculates different morphological properties for each particle including the length (L) and equivalent diameter (D). Aspect ratio is calculated by the software as length divided by diameter (AR=L/D)). The average measurements and calculations are based on images taken of at least 50 particles from a particular batch of porous catalytic carrier particles.

In the foregoing, reference to specific embodiments and the connections of certain components is illustrative. It will be appreciated that reference to components as being coupled or connected is intended to disclose either direct connection between said components or indirect connection through one or more intervening components as will be appreciated to carry out the methods as discussed herein. As such, the above-disclosed subject matter is to be considered illustrative, and not restrictive, and the appended claims are intended to cover all such modifications, enhancements, and other embodiments, which fall within the true scope of the present invention. Moreover, not all of the activities described above in the general description or the examples are required, that a portion of a specific activity cannot be required, and that one or more further activities can be performed in addition to those described. Still further, the order in which activities are listed is not necessarily the order in which they are performed.

The disclosure is submitted with the understanding that it will not be used to limit the scope or meaning of the claims. In addition, in the foregoing disclosure, certain features that are, for clarity, described herein in the context of separate embodiments, can also be provided in combination in a single embodiment. Conversely, various features that are, for brevity, described in the context of a single embodiment, can also be provided separately or in any subcombination. Still, inventive subject matter can be directed to less than all features of any of the disclosed embodiments.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

Thus, to the maximum extent allowed bylaw, the scope of the present invention is to be determined by the broadest permissible interpretation of the following claims and their equivalents, and shall not be restricted or limited by the foregoing detailed description.

What is claimed is:

1. A method of forming a batch of porous catalytic carrier particles, wherein the method comprises:
applying a precursor mixture into a shaping assembly within an application zone to form a batch of precursor porous catalytic carrier particles;
drying the batch of precursor porous catalytic carrier particles within the shaping assembly to form the batch of greenware porous catalytic carrier particles;
directing an ejection material at the shaping assembly under a predetermined force to remove the batch of greenware porous catalytic carrier particles from the shaping assembly, and
firing the batch of greenware porous catalytic carrier particles to for the batch of porous catalytic carrier particles,
wherein the batch of porous catalytic carrier particles comprises an average pore volume of at least about 0.1 cm³/g.

2. The method of claim 1, wherein applying the precursor mixture into a shaping assembly comprises extruding the precursor mixture through a die opening and into the shaping assembly, wherein the shaping assembly comprises an opening configured to receive the precursor mixture, wherein the opening is defined by at least three surfaces, wherein the opening extends through an entire thickness of a first portion of the shaping assembly, wherein the opening extends through an entire thickness of the shaping assembly, wherein the opening extends through a portion of an entire thickness of the shaping assembly.

3. The method of claim 1, wherein the shaping assembly comprises a screen, wherein the shaping assembly comprises a mold, wherein the shaping assembly comprises a first portion comprising a screen, wherein the shaping assembly comprises a second portion comprising a backing plate, wherein the first portion and the second portion are adjacent to each other in the application zone, wherein the first portion is abutting the second portion in the application zone, wherein the screen is adjacent the backing plate in the application zone, wherein the backing plate is abutting the screen within the application zone, wherein a surface of the backing plate is configured to contact the mixture in the opening of the screen.

4. The method of claim 1, wherein the precursor mixture comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

5. The method of claim 1, wherein the batch of porous catalytic carrier particles comprises alumina, silica, titania, zirconia, magnesia, silicon carbide, carbon, zeolites, metal organic frameworks (MOFs), spinels, perovskites, and combinations thereof.

6. The method of claim 1, wherein the batch of porous catalytic carrier particles comprise an average specific surface area of at least about 0.1 m²/g.

7. The method of claim 1, wherein the batch of porous catalytic carrier particles comprise an average packing density of not greater than about 1.9 g/cm³.

8. The method of claim 1, wherein the batch of porous catalytic carrier particles has an average particle diameter of not greater than about 5.0 mm and a particle aspect ratio (L/D) distribution span PARDS of not greater than about 50%, where PARDS is equal to (ARD₉₀−ARD₁₀)/ARD₅₀, where ARD₉₀ is equal to a ARD₉₀ particle aspect ratio (L/D) distribution measurement of the batch of porous catalytic carrier particles, ARD₁₀ is equal to a ARD₁₀ particle aspect ratio (L/D) distribution measurement.

9. A batch of porous catalytic carrier particles comprising an average particle diameter of not greater than about 5.0 mm and a particle aspect ratio (L/D) distribution span PARDS of not greater than about 50%, where PARDS is equal to (ARD₉₀−ARD₁₀)/ARD₅₀, where ARD₉₀ is equal to a ARD₉₀ particle aspect ratio (L/D) distribution measurement of the batch of porous catalytic carrier particles, ARD₁₀ is equal to a ARD₁₀ particle aspect ratio (L/D) distribution measurement.

10. The batch of porous catalytic carrier particles of claim 9, wherein the batch of porous catalytic carrier particles comprises alumina, aluminum trihydrate, boehmite, bayerite, silica, titania, titanium hydroxide, zirconia, zirconium hydroxide, magnesia, magnesium hydroxide, silicon carbide, carbon, zeolites, metal organic frameworks (MOFs), spinels, perovskites, or combinations thereof.

11. The batch of porous catalytic carrier particles of claim 9, wherein the batch of porous catalytic carrier particles comprise an average pore volume of at least about 0.1 cm³/g.

12. The batch of porous catalytic carrier particles of claim 9, wherein the batch of porous catalytic carrier particles comprise an average specific surface area of at least about 0.1 m²/g.

13. The batch of porous catalytic carrier particles of claim 9 wherein the batch of porous catalytic carrier particles comprise an average packing density of not greater than about 1.9 g/cm³.

14. The batch of porous catalytic carrier particles of claim 9, wherein the batch of porous catalytic carrier particles comprise a plurality of particles having a columnar shape.

15. A system for forming a batch of porous catalytic carrier particles, wherein the system comprises:
an application zone comprising a shaping assembly including a first portion having an opening and configured to be filled with a precursor mixture to form a batch of precursor porous catalytic carrier particles, and a second portion abutting the first portion;
a drying zone comprising a first heat source and being configured to dry the batch of precursor porous catalytic carrier particles to form the batch of greenware porous catalytic carrier particles;
an ejection zone comprising an ejection assembly configured to direct an ejection material toward the opening in the first portion of the shaping assembly to remove the batch of porous catalytic carrier particles from the shaping assembly, and
a firing zone comprising a second heat source configured to form the batch greenware porous catalytic carrier particles into the batch of porous catalytic carrier particles.
